(19) United States
(12) Patent Application Publication
(10) Pub. No.: US 2017/0102451 A1
(43) Pub. Date: Apr. 13, 2017

(54) METHODS AND SYSTEMS FOR PROVIDING A PERSONAL AND PORTABLE RANGING SYSTEM

(71) Applicant: Companion Bike Seat, San Francisco, CA (US)

(72) Inventors: Paul O'Leary, San Francisco, CA (US); Greg Kress, San Francisco, CA (US); Bayard Gardineer, San Francisco, CA (US); Nathaniel Gaskin, San Francisco, CA (US); Scott MacDonald, San Francisco, CA (US); Agustus Shelander, San Francisco, CA (US); Lorin Pilorin, San Francisco, CA (US)

(21) Appl. No.: 15/292,010

(22) Filed: Oct. 12, 2016

Related U.S. Application Data
(60) Provisional application No. 62/240,159, filed on Oct. 12, 2015.

(51) Int. Cl. G01S 7/00; G01S 13/08; G01S 17/87; G01S 15/87; G01S 17/08; G01S 13/87; G01S 15/08

(52) U.S. Cl. CPC G01S 7/003; G01S 13/87; G01S 13/08; G01S 15/08; G01S 15/87; G01S 17/08; G01S 17/87

(57) ABSTRACT

A system for providing a personal and portable ranging system that is configured to make a user more aware of the objects surrounding them. The ranging system comprising a sensor unit comprising at least one ranging sensor, a processing unit configured to receive information obtained from the at least one ranging sensor and configured to provide at least one output notification signal, and a notification device configured to provide at least one alert signal in response to the at least one output notification signal. The notification device can provide information regarding objects detected by the ranging system.

### RELATED APPLICATION

This application claims the benefit of priority of U.S. Provisional Application Ser. No. 62/240,159 to Paul O'Leary et al., filed on Oct. 12, 2015. The contents of Ser. No. 62/240,159 including its drawings, schematics, diagrams and written description, are hereby incorporated in their entirety by reference.

### BACKGROUND

Field

This disclosure relates to a personal ranging system. More specifically, the disclosure is directed to a personal and portable ranging system that is arranged to make a user more aware of the objects surrounding them.

Description of the Related Art

Pedestrians and slow-moving vehicles such as bicycles, must often share roads and highways with many types of fast-moving vehicles. In many cases, the pedestrian or slow-moving vehicle may not be visible to oncoming traffic. The pedestrian or slow moving vehicle, may not be aware of the approaching high speed traffic. This is a situation that can easily result in a serious accident.

Bicycles are typical of slow-moving vehicles with high potential for being victims of accidents with faster vehicles. Bicyclists rarely move as fast as normal highway traffic. They often are not completely aware of their surroundings due to poor visibility, helmets, wind noise, varying terrain, and other environmental factors. Most cycling traffic accidents occur either because the cyclist did not anticipate the approaching vehicle (often from the rear) or the driver of the vehicle did not see the cyclist in time to take evasive action.

In addition to cyclists, there are many other potential victims of fast-moving vehicles both on and off the road. These include pedestrians, skiers, highway workers, roller-bladders, skaters, and other personnel that must use highways, roads, or trails where visibility may be limited. Larger vehicles with limited visibility, including motorcycles, horse-drawn vehicles, and farm vehicles, may also be involved in accidents with rapidly approaching vehicles.

To reduce the possibility of accidents, slow moving, limited-visibility vehicles, and pedestrians would be aided by a proximity detector that would warn them of oncoming traffic and make the oncoming traffic aware of their presence. A vehicle proximity-alerting device could help avoid many of these potential accidents and possibly decrease the morbidity and mortality of cyclists, pedestrians, and others.

The disclosure is a personal and portable ranging system that is configured to detect obstacles and/or oncoming vehicles and can be used in many different settings. For example, the ranging system can be used by a pedestrian and/or a vehicle to detect upcoming obstacles and/or oncoming traffic.

The disclosure addresses these needs and provides further related advantages.

### SUMMARY

The disclosure provides various aspects of a system for providing a personal and portable ranging system that is configured to make a user more aware of the objects surrounding them. The ranging system comprises elements to allow the ranging system to be configured to be used in many different arrangements, such that the ranging system can be used by a pedestrian, a vehicle, or the like. The ranging system can be used in many different settings, such as roads, highways, trails, bike paths and the like. The disclosure provides a ranging systems that can be easily operated by a single individual.

In one aspect of the disclosure, as broadly described herein, a ranging system comprises a sensor unit comprising at least one ranging sensor, a processing unit configured to receive information obtained from the at least one ranging sensor and configured to provide at least one output notification signal, and a notification device configured to provide at least one alert signal in response to the at least one output notification signal. The notification device can provide information regarding objects detected by the ranging system.

Further disclosed herein is a method of notifying a user of surrounding objects. In one aspect, as broadly described herein, the method comprises scanning an area, collecting data on objects within the scanned area, processing the collected data, and providing an output notification signal to a notification device, wherein the notification device is configured to provide at least one alert signal of objects detected within the scanned area.

This has outlined, rather broadly, the features and technical advantages of the disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

FIG. 1 is block diagram of a ranging system according to an aspect of the disclosure.

FIG. 2a is a diagram of a sensor unit according to an aspect of the disclosure.

FIG. 2b is a diagram of a sensor unit according to an aspect of the disclosure.

FIG. 2c is a diagram of a sensor unit according to an aspect of the disclosure.

FIG. 3 is a perspective view of a ranging system according to an aspect of the disclosure.

FIG. 4 is a perspective view of a ranging system according to an aspect of the disclosure.

FIG. 5a is a diagram a network of ranging systems according to an aspect of the disclosure.

FIG. 5b is a diagram of a network of ranging systems according to an aspect of the disclosure.

FIG. 6a is a block diagram of a method of notifying a user of surrounding objects according to an aspect of the disclosure.

FIG. 6b is a block diagram of a method of notifying a user of surrounding objects according to an aspect of the disclosure.

FIG. 7 is a perspective view of a notification unit according to an aspect of the disclosure.

### DETAILED DESCRIPTION

The disclosure is directed to methods and systems for providing a personal and portable ranging system. The ranging system is configured to make a user more aware of the objects surrounding them. In one aspect, the ranging system comprises a sensor unit comprising one or more ranging sensors configured to collect information directed to a user's surroundings, such as but not limited to objects and/or obstacles. The information collected can comprise where objects are located relative to the user, whether the objects are stationary or moving, the rate at which the objects are moving, and in what direction they are moving relative to the user. This information is processed and organized into an output notification signal. The information comprised in the output notification signal is then communicated to the user through one or a combination of different methods, including but not limited to lights, visual displays, sounds, and integrations with phones, smartphones, and other present and future devices (eg. Google Glass) that are configured to communicate information visually, audibly, tactilely or a combination thereof to the user.

The ranging system comprises a sensor unit comprising the one or more ranging sensors that are configured to detect objects in proximity to the user. The one or more ranging sensors can also be configured to transmit the collected information to a processing unit. The processing unit is configured to receive the information and is configured to process the information in order provide at least one output notification signal that is transmitted to a notification device by a transmission unit. Examples of information provided in the at least one output notification signal can comprise the position, speed, trajectory of any object within range of the sensor or sensors and/or a combination thereof. The disclosure is not intended to be limited to the examples disclosed herein, as such, other data points and/or information of the scanned area can be provided in the output notification signal.

The range of detection of the sensor unit, which is the distance that an object can be detected relative to the sensor unit, can be dependent upon many different factors, such as but not limited to the type of sensor used or the environment in which the sensor unit is used. In one aspect, the sensor unit can have a range of detection of 0-300 feet, while in some aspects the sensor unit can have a range of detection of 0-100 feet, and yet in other aspects the sensor unit can have a range of detection of 0-50 feet. These ranges are intended to be non-limiting examples and are not intended to limit the scope of the disclosure. In some aspects, the range of detection of the sensor unit can be adjusted to be increased or decreased based on certain conditions, such as but not limited to, terrain, weather, rate of speed of the user, or surrounding objects. The ranging sensors can be comprised of many different ranging technologies, such as but not limited to ultrasound, LIDAR, RADAR, imaging, magnetic induction and the like or a combination thereof. In some aspects, the ranging sensor can comprise an imaging device configured to obtain and/or collect video and/or still images, wherein the video and/or images are analyzed by an image recognition software in order to identify objects within range of the ranging sensor and determine their relative distance and/or trajectory from the ranging sensor.

The processing unit is configured to provide at least one output notification signal of information obtained by the sensor unit to the transmission unit, wherein the transmission unit is configured to transmit the at least one output notification signal to the notification device for communication to the user. The notification device can be comprised of software for smart phones or other portable electronic devices, a separate piece of hardware that can be carried by the user, or both. Transfer of information from the processing unit to the notification device may be done via a wired connection or a wireless connection.

In one aspect of the invention, the ranging system may further comprise at least one component to house the sensor unit, the processing unit, and the transmission unit. In one aspect, the at least one component is a housing wherein the sensor unit, the processing unit, and the transmission unit are within the housing. The housing can provide protection from environmental conditions, as well as provide protection against physical damage. In some aspects, the sensor unit, the processing unit and the transmission unit can be mounted within the housing, while in other aspects, the sensor unit, the processing unit and the transmission unit can be received within the housing allowing for ease of removal. In other aspects, the sensor unit, processing unit, and transmission unit may be housed separately, wherein the connection between the units may be wired, wireless or a combination thereof.

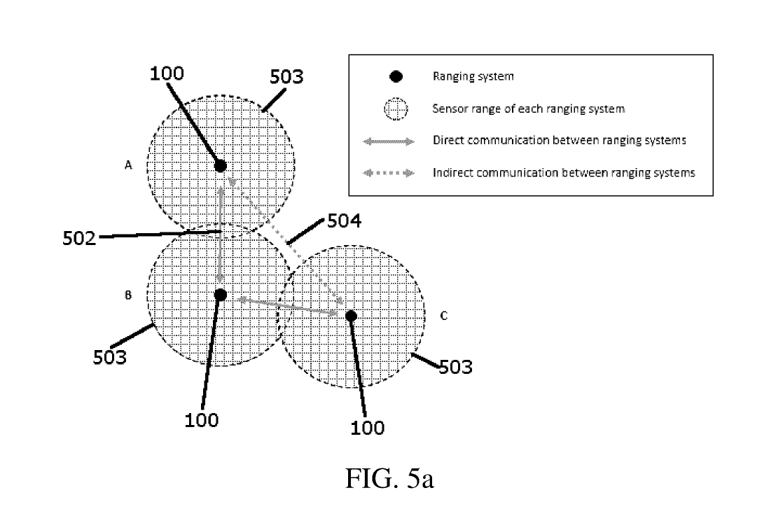

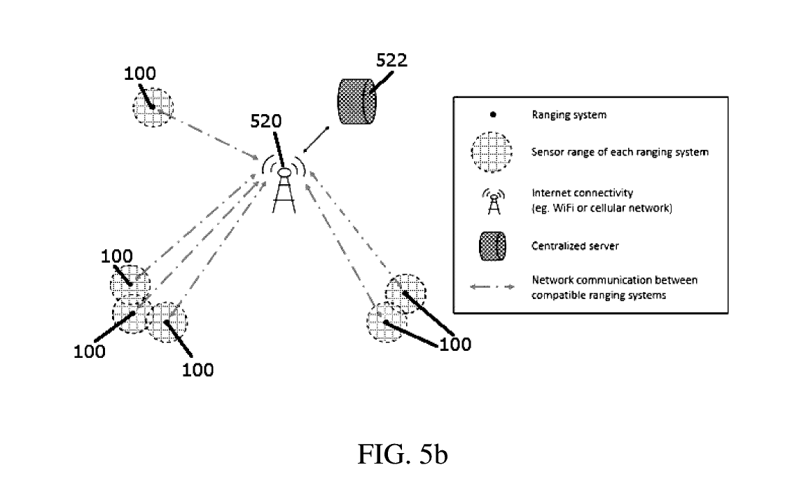

In some aspects, the notification unit may be comprised of software or hardware, or both software and hardware. The software may be a mobile application operated on a portable electronic device or a website operated on a server that receives the information from the transmission unit and displays information to the user in response to the data received from the transmission unit. The ranging system does not need to be connected to a network (i.e. the internet or a local network) to function. However, in some aspects, the ranging system can be connected to a network, such as but not limited to the Internet, a local network, or the like, which may enable users with compatible ranging systems to communicate with each other and share information about the objects surrounding each ranging system connected to the network. This network may be created by the ranging systems themselves, as diagrammed in FIG. 5a, or through connectivity to the Internet, as diagrammed in FIG. 5b. The hardware of the notification device may be a physical unit that is configured to communicate the notification signals received from the transmission unit in a number of different ways, such as but not limited to displays light, emits sound, and/or can vibrate to communicate information to the user.

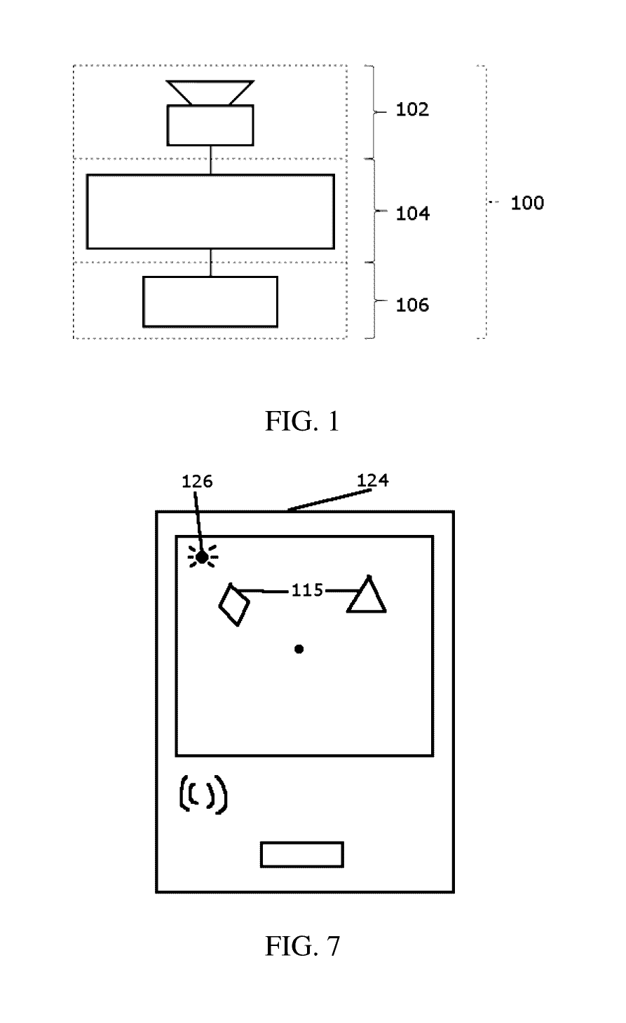

FIG. 1 discloses a diagram of an aspect of the portable ranging system 100. The ranging system 100 comprises a sensor unit 102, a processing unit 104 and a transmission unit 106, wherein the sensor unit 102 is connected to the processing unit 104 and the processing unit is connected to the transmission unit 106. The connection between the sensor unit and processing unit can be a physical wire connection or a wireless connection. The connection between the processing unit and the transmission unit can be a physical wire connection or a wireless connection. The connection between the sensor unit and the processing unit allows the sensor unit and the processing unit to communicate with each other. The connection between the processing unit and the transmission unit allows the processing unit and the transmission unit to communicate with each other. In some aspects, the sensor unit 102 can communicate to the transmission unit 106 either through its connection with the processing unit 104 or could have a separate connection with the transmission unit 106 by-passing the processing unit 104.

The sensor unit 102 is configured to scan a particular area and to collect data about the objects within the particular area. The collected data provides information about objects within the scanned area, such as but not limited to, moving objects, stationary objects, size of objects, rate of speed of moving objects, direction of moving objects, etc. The collected data allows the user to be aware of the objects within the scanned area, which allows the user to determine whether to proceed along the scanned particular area or to alter their course. The ranging system could assist users in altering their course due to objects and/or obstacles that are not readily visible.

The ranging system 100 can comprise one or multiple technologies to detect objects. In some aspects, the sensor unit can comprise ultrasonic sonar, LIDAR (light detection and ranging), RADAR, magnetic induction, optical/image processing sensors, and/or a combination thereof. The ranging system may contain its own power-supply (e.g. internal rechargeable battery) or be powered by an external source of power (e.g. hub-mounted dynamo or photovoltaic cell).

In one aspect, the sensor unit can comprise a single static LIDAR sensor that provides a narrow angle of detection that may be only a few degrees. In some aspects of the ranging system, combining one or multiple sensors in different orientations can provide a wider angles of detection. In one aspect, the sensor unit can have an angle of detection of 360 degrees, while in some aspects the sensor unit can have an angle of detection of 270 degrees, and yet in other aspects the sensor unit can have an angle of detection of 170 degrees. These ranges are examples and are not intended to limit the disclosure. In yet other aspects, the angle of detection of the sensor unit can be adjustable to be increased or decreased, and is not intended to be limited to a set angle of detection.

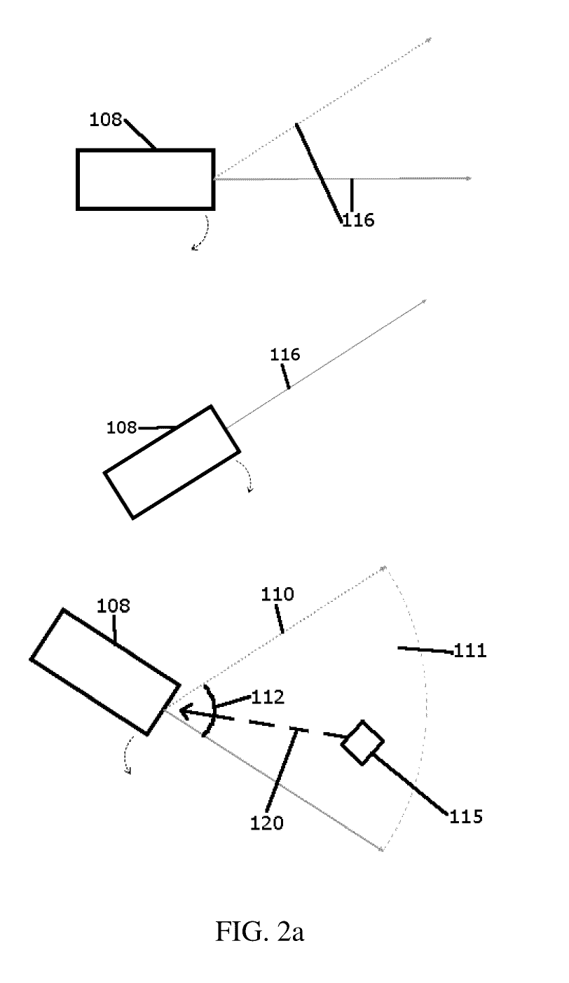

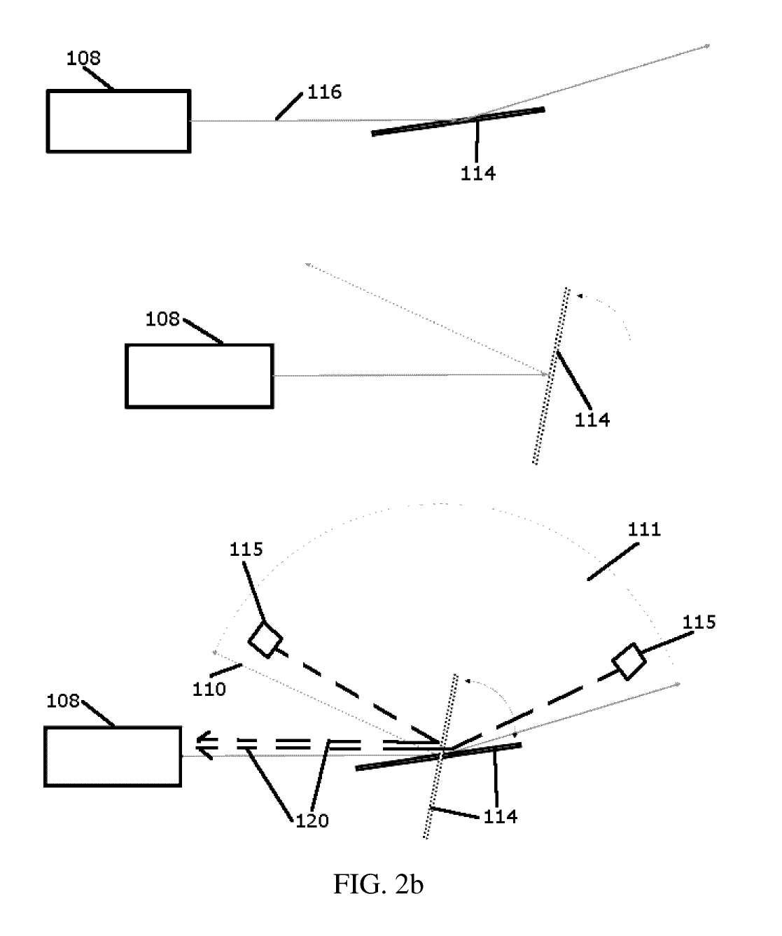

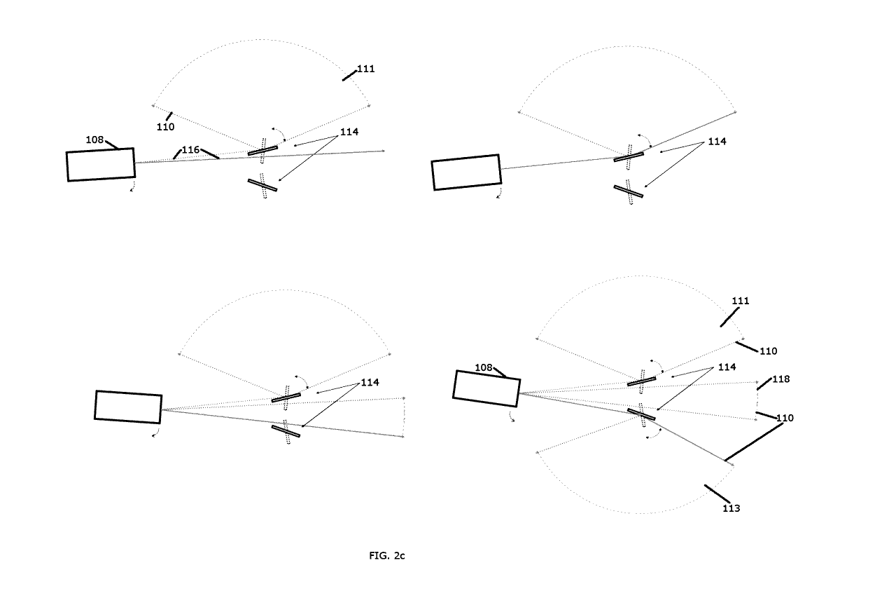

In another aspect, as shown in FIG. 2a, the sensor unit can comprise a single LIDAR sensor 108 affixed to a servo or DC motor (not shown) that oscillates back and forth laterally in order to scan an area 111. The servo or DC motor allows the LIDAR sensor 108 to oscillate and thereby increase the area 111 the LIDAR sensor can scan, wherein the beam width 110 of the LIDAR sensor can be determined, in part, by the range of oscillation 112 of the servo of DC motor. In some aspects, the range of oscillation 112 can be predefined, while in other aspects, the range of oscillation 112 can be alterable by the user to narrow or widen the range of oscillation, and thereby adjust the beam width 110 of the LIDAR sensor 108. It is known that LIDAR units illuminate a target with a laser light, and typical lasers emit light that is collimated and/or concentrated resulting in a narrow beam width. The servo or DC motor oscillates the LIDAR sensor 108 thereby increasing the area which the LIDAR sensor could scan in comparison to a stationary LIDAR sensor.

In another aspect, as shown in FIG. 2b, the angle of detection or beam width 110 of a LIDAR sensor 108 can be increased by using a mirror and/or other reflective device 114 that is configured to oscillate laterally while the LIDAR sensor 108 is stationary. In the aspect of FIG. 2b, a laser beam 116 from the LIDAR sensor 108 is directed towards the mirror or reflective device 114 and is reflected out to scan an area 111 and detect objects 115. The oscillating mirror 114 is separated from the LIDAR sensor 108 such that the oscillating mirror is remote from the LIDAR sensor. The oscillating mirror 114 allows the LIDAR sensor 108 of the aspect of FIG. 2b to remain stationary while increasing the beam width 110 or the angle of detection of the LIDAR sensor 108. At least one advantage of the aspect of FIG. 2b is that the area 111 that can be scanned by the LIDAR sensor 108 can be increased while maintaining the LIDAR sensor in a stationary position. Yet another advantage is that the light beam 116 emitted by the LIDAR sensor 108 to the mirror 114 will always be along the same path, such that clearance from the other elements of the ranging system 100 can be minimized in order for the light to reach the oscillating mirror 114.

In yet another aspect, as shown in FIG. 2c, a LIDAR sensor 108 can be affixed to an oscillating motor (not shown) and pointed towards one or more oscillating mirrors 114 to increase the angle of detection 110. In the aspect of FIG. 2c, there are two oscillating mirrors 114, 114 opposite each other and spaced apart from each other. The light 116 is emitted from the LIDAR sensor 108 towards a first mirror 114, and is reflected by the first mirror 12 to scan an area 111, in a manner similar to the aspect of FIG. 2b. However, in the aspect of FIG. 2c, the LIDAR sensor 108 can oscillate, such that the LIDAR sensor can also emit light 116 to a second oscillating mirror 114. As the LIDAR sensor 108 oscillates, light 116 can be emitted from the LIDAR sensor towards the second mirror 114, which is then reflected by the second mirror 114 to scan a different area 113 than that of the first oscillating mirror 114, in a manner similar to the first oscillating mirror 114. This arrangement significantly increases the beam width 110 of the LIDAR sensor 108, while minimizing the movement of the LIDAR sensor 108. The LIDAR sensor 108, in the aspect of FIG. 2c, does not have a range of oscillation that corresponds to the beam width 110 of the LIDAR sensor 108, which assists improves accuracy of the collected object data points 120. As further shown in FIG. 2c, the first and second oscillating mirrors 114, 114 are spaced apart from each other and provide a region 118 for which light 116 from the LIDAR sensor 108 is not reflected. The spacing between the first and second oscillating mirrors 114, 114 can also be an area to be scanned by the LIDAR sensor 108. At least one advantage of the aspect of FIG. 2c is that the oscillation of the LIDAR sensor 108 can be minimized due in part to the separation of the first and second mirrors, while significantly increasing the beam width 110 or the angle of detection of the LIDAR sensor 108. The range of oscillation of the LIDAR sensor would be much smaller in comparison to the range of oscillation of the mirrors, such that the clearance required for the light path of the light emitted from the LIDAR sensor 108 to the oscillating mirrors 114 can be minimized and does not require a wide range of oscillation in order to scan a wide area. In some aspects, the first and second oscillating mirrors have the same range of oscillation, while in other aspects, the first and second oscillating mirrors do not have the same range of oscillation and oscillate at different ranges. In some aspects, the first and second mirrors oscillate at the same rate or can oscillate at different rates. The oscillation of the first and second mirrors can be synchronized with respect to each other, the LIDAR sensor or a combination thereof such that the mirrors are in a position to reflect light from the LIDAR sensor when the LIDAR sensor emits light toward the mirrors. Furthermore, the range of oscillation of the first and second mirrors can be pre-defined or adjustable to alter the beam width or angle of detection of the LIDAR sensor. Furthermore, the object data points collected by the LIDAR sensor can also comprise information about the oscillating mirror as to its position during its range of oscillation for each object data point collected. The information regarding the position of the oscillating mirror is used to determine the location of the item detected within the scanned area.

In the aspect of FIGS. 2a and 2c, the LIDAR sensor is described as being configured to oscillate laterally, with respect to the ground or a surface. However, the disclosure is not intended to be limited to the sensor unit oscillating laterally. In some aspects, the sensor unit can oscillate in many different directions. For example, the sensor unit can oscillate vertically with respect to the ground. In yet other aspects, the sensor unit can oscillate vertically and laterally at the same time with respect to the ground.

In the aspect of FIGS. 2b and 2c, the oscillating mirror are described as being configured to oscillate laterally with respect to the LIDAR sensor. However, the disclosure is not intended to be limited to the oscillating mirrors oscillating laterally. In some aspects, the oscillating mirror can oscillate vertically with respect to the sensor unit. In yet other aspects, the oscillating mirror can oscillate vertically and laterally at the same time. Furthermore, the oscillating mirrors are shown as planar mirrors, but the disclosure is not intended to be limited to planar mirrors. The oscillating mirrors can be any shape, such as but not limited to, circular, triangular, or any other polygonal shape. Also, the surface of the oscillating mirror can comprise surface features that contribute to the reflective properties of the mirror. For example, the mirror can comprise a multi-faceted surface, roughened surface, convex surface, concave surface, or a combination thereof. The oscillating mirrors of FIGS. 2b and 2c are shown as having a range of oscillation that is less than 180 degrees. However, in other aspects, the oscillating mirrors can have various ranges of oscillation and is not intended to be limited to the aspects disclosed herein. For example, in some aspects, the oscillating mirrors can have a range of oscillation greater than 180 degrees, wherein the oscillating mirror can comprise one or a plurality of reflective surfaces. In yet other aspects, the oscillating mirrors can have a range of oscillation of 360 degrees and have at least one reflective surface.

In another aspect of the disclosure, the sensor unit 102 can comprise optical features, such as but not limited to, lenses, reflectors, diffusers, the like, or a combination thereof, to alter, adjust, spread, increase and/or decrease the area of detection of the sensor unit. The above aspect has been described as the sensor unit comprising a LIDAR sensor 108. However, the disclosure is not intended to be limited to a LIDAR sensor, and other known sensing technologies can be used, such as but not limited to ultrasonic sonar, RADAR, magnetic induction, and optical/image processing sensors. For example, ultrasonic sonar, RADAR, magnetic induction, and optical/image processing sensors all have much broader angles of detection than LIDAR. In other aspects of the disclosure, the ranging system 100 can comprise one or more of these sensor units affixed stationary or oscillated laterally via a motor to provide the entire visible range for the ranging system. While in other aspects, the one or more sensor units can be used in combination with one or more beam altering devices, such as but not limited to optical features, to alter and/or adjust the visible range of the ranging system. Data from a ranging system comprising multiple sensors could be combined using a Kalman-type filter or the like to provide a more accurate and/or broader range of detection.

In another aspect of the disclosure, the sensor unit 102 can comprise one or more cameras configured to collect images and/or video of the surrounding area within the range of detection of the sensor unit 102. The collected images and/or video form a data stream that is transmitted by the sensor unit to the processing unit 104, wherein the processing unit comprises an image recognition system that processes the data stream of images and/or video collected by the sensor unit 102 in order to identify objects that are captured in the images and/or video. The image recognition system is configured to process the data stream of images and/or video to determine relative distance, speed, and/or trajectory of identified objects, relative to the sensor. The results of the processed data stream form an output notification signal which is transmitted to the notification unit in order to alert the user of the ranging system of the proximity and/or movement of the objects.

The sensor unit 102 receives a signal of discrete object data points 120 of objects in time and space within range of the one or more sensors 108 and transmits ranging information to the processing unit 104. Based on the position of the sensor 102 when the signal is received, the last data point collected from the sensor and sensor position (or neighboring sensor or sensor position), and the time elapsed between those data points 120, the processing unit 104 processes the ranging information from the sensor unit 102 and identifies individual objects 115 and maps their position, speed, acceleration, and trajectory with respect to the sensor unit. The processing unit 104 creates an output notification signal 122 that is transmitted to the transmission unit. The output notification signal 122 can comprise a two-dimensional field of any detected objects within range of the sensor unit 102 with respect to the sensor unit.

The information of detected objects and their position, speed, and trajectory is transmitted from the transmission unit 106 to a notification device 124 and is used to create at least one alert signal 126, which in some aspects, can comprise a two-dimensional representation of the objects that are in range of and detected by the sensor unit 102. In some aspects, the two-dimensional representation of the surrounding objects and their movements is communicated to the user via a visual display (notification device) 124 that shows the objects detected with respect to the user in a two-dimensional plane, as shown in FIG. 7. In some aspects of the disclosure, the processing unit 104 can be programmed to provide additional “alerts” or alert signals 126, such as but not limited to auditory, visual, and/or tactile notifications, based on whatever stimuli is necessary for the particular application. For example, some alert signals 126 could be in response to the detection of a fast approaching object with respect to the sensor unit 102 in order to alert the user of the fast approaching object. The processing unit 104 can also be programmed to provide customized “alerts” or alert signals 126 as desired for various applications. For example, a processing unit 104 can be programmed to toggle between different modes, such as but not limited to pedestrian, bicycle, motorcycle, etc., wherein each mode can provide a set of alert signals 126 based on the selected mode. In some aspects, toggling between different modes could provide operational instructions to the sensor unit 102, processing unit 104, or transmission unit 106 based on the different modes. For example, the sensor unit 102 could have a different set of instructions for motorcycle mode in comparison to pedestrian mode due in part to the motorcycle travelling at a different rate of speed than a pedestrian. The processing unit 104 can also be configured to provide a customized set of alert signals 126 defined by a user, or allows the user to modify the alert signals 126 for each of the different modes.

With some sensors, it may be possible to detect additional information about objects in range, including heat or light emitted by the objects. This information can be used by the ranging system to not only communicate distance, speed, and trajectory of surrounding objects, but also what type of objects they might be based on additional information collected from them by the sensor. This aspect of the disclosure could require additional signal processing from the sensor unit data by the processing unit 104 to determine what type of object it is. This additional signal processing takes all of the object data points 120 from the sensors 102, including but not limited to speed, temperature, or light reflection characteristics, and matches them against a database of known characteristics of common objects to identify the potential type of object as it approaches the ranging system. In this aspect, the database can be pre-programmed into the processing unit 104, after being created by vigorous testing of the ranging system.

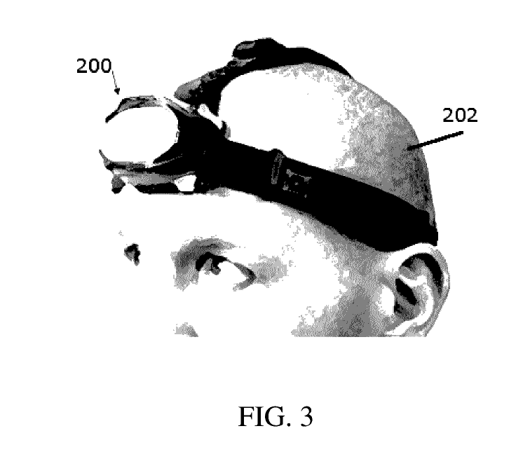

In one aspect of the disclosure for use with pedestrians (e.g. hikers, hunters, soldiers, etc.), a ranging system 200 can be affixed to the head or other body part 202 of the user via elastic or other refastening band (much like a headlamp), or attached to a hat or helmet that is configured for use with the sensor unit. See FIG. 3 for a drawing of the portable ranging system affixed to the head of a user. In another aspect, the ranging system can be similarly affixed to the arm or wrist of the user. In another aspect, the ranging system can be a hand-held device, and may or may not include the notification unit built into the device. In another aspect, the ranging system can be carried on the back of the user in a backpack that is configured for use with the sensor unit. In another aspect, the ranging system is embedded into an article of clothing (a hat, a shirt, a jacket, a glove, etc.) or handbag or backpack or other such commonly worn or carried accessory. In another aspect, the ranging system is built directly into a wristwatch or phone/smart-phone or other hand-held device.

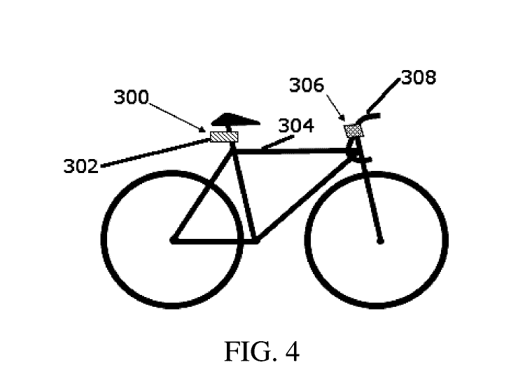

In one aspect of the disclosure for use with bicyclists, a ranging system 300 is housed in a single housing 302, while in other aspects, the multiple components can be individually housed separately, all of which are affixed to a bicycle frame or bicycle rack 304 via clamp, band, or strap made of any variety of materials, so that the ranging system 300 remains affixed to the bicycle or bicycle rack 304 and does not substantially move with respect to the bicycle while the bicycle moves and/or encounters uneven terrain. In various aspects, the ranging system 300 may or may not require the need to aim the sensor unit and/or ranging system in a specific direction when affixing the ranging system to the bicycle 304. In some aspects, a notification unit 306 can be mounted to the handlebars 308 of the bicycle 304, while in other aspects, the notification unit 306 can be mounted to other parts of the bicycle 304 and is not intended to be limited to the handlebars 308. In yet other aspects, the notification unit 306 can be on the user. The ranging system 300 provides the rider awareness of objects to the rear as well as in blind spots on either side while riding. See FIG. 4 for a diagram of one aspect of how the ranging system 300 could be affixed for use on a bicycle 304. In another aspect the ranging system is built directly into the bicycle frame itself (as part of the bicycle), or is built into a bicycle accessory such as a cargo rack or a bicycle light.

In one aspect of the disclosure for use with motorcyclists, the ranging system is housed in a single or multiple components, all of which are affixed to the frame of the motorcycle via customized mounting bracket, so that the ranging system remains affixed to the motorcycle and does not substantially move with respect to the motorcycle while the motorcycle moves and/or encounters uneven terrain. In various aspects, the ranging system may or may not require the need to aim the sensor unit and/or ranging system in a specific direction when affixing the ranging system to the motorcycle. In some aspects, a notification unit can be mounted on or near the handlebars of the motorcycle, while in other aspects, the notification unit can be mounted to other parts of the motorcycle and is not intended to be limited to the handlebars. This way the ranging system is able to provide the rider additional awareness of objects to the rear as well as in blind spots on either side.

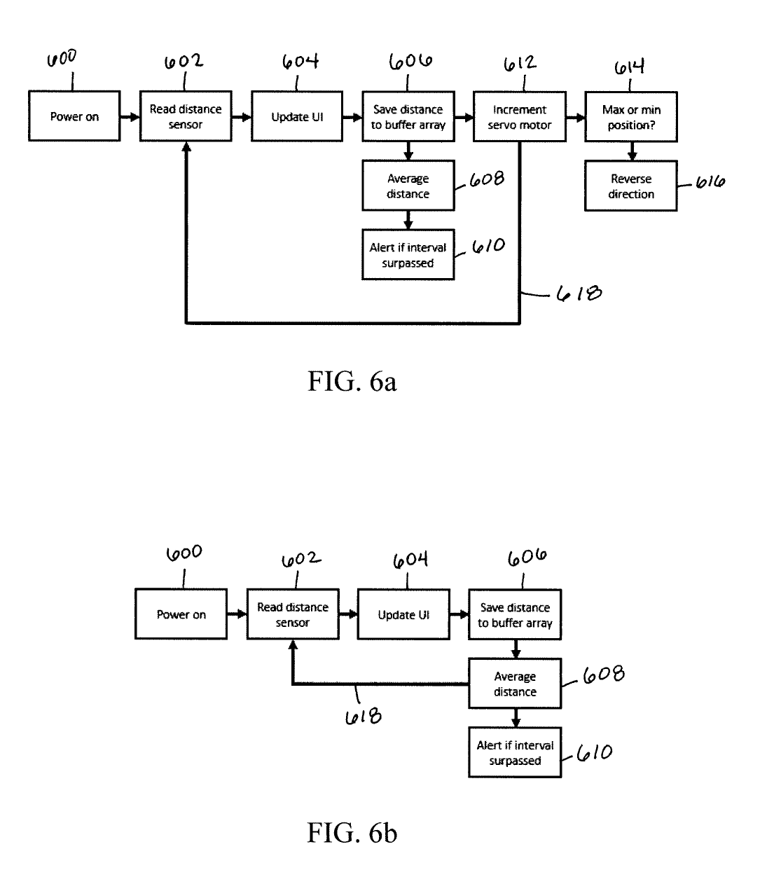

The following is a description of one aspect of the logic flow circuit for a method of using the portable ranging system, as shown in the diagram of FIG. 6a:
Power on 600: initiates power from the power supply (battery source) to the sensor unit, processing unit, and transmission unit (and to the notification if applicable); software loop is initiated 618.
Read distance sensor 602: scan the field and take measurement of distance of any object in the path from the particular sensor (if more than one) based on the sensor read, taking into account the position of the sensor with respect to the virtual visual field created by the sensor unit
Update UI 604: send information regarding distance and position of all objects to the transmission unit, and transmit this information to the notification unit
Save distance to buffer array 606:
   Average distance 608: save distance and time of last-seen object at each position of the sensor (or sensor-mirror apparatus). If variance in distance of an object is seen for any reading from a particular position (or neighboring position) in sequence (time), calculate velocity and trajectory of moving object. Variance in distance is averaged based on the update-rate of the sensor and of the notification unit to produce “smooth movement” (eliminating signal “noise”) of an object within range of the ranging system.
   Alert if interval surpassed 610: if velocity and trajectory of an object within the visible range of the sensor unit exceeds certain thresholds (that can be modified and programmed for customization), the processing unit sends additional “alerts” or alert signals to the transmission unit, which transmits this to the notification unit. The frequency of the alert can be adjusted according to distance, velocity and trajectory values. These alerts can then be communicated to the user through auditory, visual, and tactile methods.
Increment servo motor 612 (if applicable for sensor configuration): if sensor or sensor mirror is affixed to a motor and is oscillating laterally, move sensor or sensor mirror to the next position in the sensor-position-sequence for that particular sensor
   Max or min position 614: check if the sensor or sensor mirror is in the maximum or minimum position for the sensor-position-sequence for that particular sensor. If yes:
      Reverse direction 616: reverse direction of the sensor or sensor mirror, as per sensor-position-sequence programmed into the sensor unit and the processing unit

In an aspect of the disclosure using a sensor system that does not require any oscillation, the increment servo motor, max or min position, and reverse direction steps in the logic flow circuit described above are unnecessary for the function of the portable ranging system, as shown in the diagram FIG. 6b.

In an aspect of the disclosure using multiple sensors operating simultaneously, there may be additional steps in the logic flow circuit after reading the distance sensor taking into account the position of the sensor relative to the other sensors in order to merge the object distance information together into a single picture of objects in range surrounding the sensor unit.

In an aspect of the disclosure where the sensor is not required to be pointed in a certain direction (eg. horizontal to the ground), a gyroscope may be utilized to determine the position of the sensor or sensors relative to the plane of the earth. In this aspect, the gyroscope is built into the sensor unit and communicates information to the processing unit along with the information from the sensors. The processing unit uses information from the gyroscope to determine which data from the sensor unit to process and communicate to the user, and which data to ignore.

In another aspect of the disclosure where the sensor is able to detect additional information about an object beyond its distance and position, there may be additional data processing steps before sending the information to the transmission unit to clean-up or enhance the data. This may include searching a catalog of known object characteristics to determine the type of object (based on the catalog), and saving this information to the buffer array along with the distance information. The object type would then also be sent to the transmission unit for communication to the user of the portable ranging system.

In one aspect of the disclosure, the transmission unit 106 is configured to communicate wirelessly to separate or remote ranging systems 100 that are in range 503 of the sensor unit 102. This provides the ability for the information collected by the sensor unit 102 to be communicated directly 502 or indirectly 504 to multiple ranging systems 100 within range 503 of each other, including other pedestrians, bicyclists, motorcyclists, or automobile drivers that have compatible ranging systems. A diagram of this aspect in FIG. 5a shows both direct communication 502 between ranging systems 100 in range 503 of each other, as well as indirect communication 504 between ranging systems that are outside of each other's range 503 directly, but share a compatible ranging system 100 in range 503 and can still “see” each other. The shared compatible ranging system 100 acts as a conduit between ranging systems 100 beyond range 503 such that the ranging systems beyond range 503 can communicate indirectly 504 via a shared ranging system within range 503. In another aspect, the information collected by the sensor unit 102 may be transmitted wirelessly by the transmission unit 106 via the Internet 520 to a centralized server 522, creating a network of information that can be used for management and/or coordination of group movements. This aspect may require additional software to take all of the data in the centralized server 522 provided by each ranging system 100 with connectivity to the network 520, and return relevant information about these surrounding objects to each ranging system 100 with connectivity to the network 520. This may include information about objects with ranging systems 100 that are not immediately within range of each other, but can be determined by algorithms using trajectory and speed of objects directly in range, along with GPS coordinates of the sensor units themselves projected onto known maps that are available (eg. Google Maps). A diagram of the network described in this aspect can be found in FIG. 5b.

Although the disclosure has been described in considerable detail with reference to certain configurations thereof, other versions are possible. Ranging systems according to the disclosure can utilize various sensing technologies. Furthermore, the notification device can be any type of device that can provide any type of notification to a user in response to the signal received from the transmission unit, and is not intended to be limited to the aspects disclosed herein. Therefore, the spirit and scope of the invention should not be limited to the versions described above.

We claim:

1. A portable ranging system, comprising:
a sensor unit configured to collect object data points of an area within a range of detection of said sensor unit;
a processing unit configured to receive said object data points from said sensor unit and produce at least one output notification signal; and
a transmission unit configured to transmit said at least one output notification signal to a notification device, wherein said notification device is configured to provide at least one alert signal in response to said at least one output notification signal.

2. The portable ranging system of claim 1, said sensor unit comprising at least one ranging sensor configured to scan said area within an angle of detection and collect said object data points of said area within said angle of detection.

3. The portable ranging system of claim 1, wherein said sensor unit is configured to oscillate in order to scan said area within said range of detection, wherein a range of oscillation of said sensor unit is proportional to an angle of detection of said sensor unit.

4. The portable ranging system of claim 1, said sensor unit comprising:
at least one ranging sensor configured to scan said area within said range of detection; and
at least one reflective device remote from said at least one ranging sensor, wherein emissions from said at least one ranging sensor are emitted to said at least one reflective device and reflected by said at least one reflective device in order to scan said area within said range of detection.

5. The portable ranging system of claim 4, wherein said at least one reflective device is configured to oscillate such that said emissions from said at least one ranging sensor are reflected towards said area within an angle of detection of said sensor unit.

6. The portable ranging system of claim 5, wherein said angle of detection of said sensor unit is proportional to a range of oscillation of said at least one reflective device.

7. The portable ranging system of claim 4, said sensor unit comprising:
a first reflective device remote from said at least one ranging sensor; and
a second reflective device remote from said at least one ranging sensor, wherein said first and second reflective devices are spaced apart from each other;
wherein said first and second reflective devices are configured to oscillate, such that said emissions from said at least one ranging sensor are reflected by said first reflective device to a first area, and said emissions from said at least one ranging sensor are reflected by said second reflective device to a second area.

8. The portable ranging system of claim 7, wherein said at least one ranging sensor is configured to oscillate in order to scan said first area and said second area within said range of detection.

9. The portable ranging system of claim 8, wherein a third area to be scanned is a region defined by the separation of said first and second reflective devices.

10. The portable ranging system of claim 1, wherein said notification device comprises a portable electronic device comprising a display screen, wherein said output notification signal comprises a two-dimensional representation of said object data points configured to be displayed on said display screen.

11. The portable ranging system of claim 1, said sensor unit comprising at least one ranging sensor configured to collect a plurality of images, wherein said plurality of images are processed by said processing unit to identify one or more objects within range of said at least one ranging sensor.

12. A method of using a portable ranging system, comprising:
scanning an area within a range of detection of a sensor unit;
collecting object data points of said area, wherein said object data points comprise measurements of distance and position of one or more objects detected within said range of detection;
transmitting said object data points to a processing unit;
processing said object data points based on distance and position of said one or more objects;
producing an output notification signal based on said object data points;
transmitting said output notification signal to a notification device, wherein said output notification signal comprises a two-dimensional representation of said object data points; and
displaying said output notification signal on a display of said notification device.

13. The method of claim 12, wherein said sensor unit comprises at least one ranging sensor configured to scan said area within an angle of detection and collect said object data points of said area within said angle of detection.

14. The method of claim 12, wherein said processing unit is configured to produce one or more alert signals based on said object data points, wherein said one or more alert signals are transmitted to said output notification device.

15. The method of claim 12, said sensor unit comprising:
at least one ranging sensor configured to scan said area within said range of detection; and
at least one reflective device remote from said at least one ranging sensor, wherein emissions from said at least one ranging sensor are reflected by said at least one reflective device in order to scan said area within said range of detection.

16. A network of portable ranging systems, comprising:
a plurality of portable ranging systems, wherein each of said plurality of portable ranging systems comprising:
a sensor unit configured to collect a data stream of an area within a range of detection of said senor unit;
a processing unit configured to process said data stream and produce at least one output notification signal, said at least one output notification signal comprising information of detected objects within said area; and
a transmission unit configured to transmit said at least one output notification signal to one or more of said plurality of portable ranging systems;
a connection between at least two of said plurality of portable ranging systems, wherein said at least one output notification signal is transmitted via said connection to one or more of said plurality of portable ranging systems in order to share information of said detected objects within a respective one of said plurality of portable ranging systems.

17. The network of claim 16, wherein said connection is a local connection established by said at least two of said plurality of portable ranging systems, such that said at least two of said plurality of portable ranging systems communicate directly with each other.

18. The network of claim 17, wherein said plurality of portable ranging systems can indirectly communicate with each other such that said at least one output notification signal from an originating portable ranging system can pass through one or more intermediate portable ranging systems until said at least one output notification signal is received by a destination portable ranging system.

19. The network of claim 18, wherein said connection is a network connection, wherein each of said plurality of portable ranging systems is connected to a central hub such that information of said detected objects within each of said plurality of portable ranging systems is transmitted to said central hub, wherein each of said plurality of portable ranging systems is configured to receive information of said detected objects within each of said plurality of portable ranging systems that is connected to said central hub.

20. The network of claim 19, wherein each of said plurality of portable ranging systems is configured to create an overall representation of all of said detected objects within range of each of said plurality of ranging systems connected to said central hub.
